(19) United States
(12) Patent Application Publication
(10) Pub. No.: US 2026/0163160 A1
(43) Pub. Date: Jun. 11, 2026

(54) Energy storage unit for a vehicle with exchangeable battery cell

(71) Applicant: Brose Fahrzeugteile SE & Co. KG, Würzburg, Würzburg (DE)

(72) Inventor: Holger SCHWAB, Schonungen (DE)

(21) Appl. No.: 19/217,993

(22) Filed: May 23, 2025

(30) Foreign Application Priority Data
May 24, 2024 (DE) 10 2024 114 705.9

(51) Int. Cl. H01M 50/271; B60L 50/64; H01M 50/209; H01M 50/213; H01M 50/249

(52) U.S. Cl. CPC H01M 50/271; H01M 50/209; H01M 50/213; H01M 50/249; B60L 50/64; H01M 2220/20

(57) ABSTRACT

It is provided an energy storage unit for a vehicle, wherein the energy storage unit includes a plurality of battery cells which for providing electric energy are electrically connected to a cell contacting system of the energy storage unit. At least one of the battery cells of the proposed energy storage unit is exchangeable and therefore is releasably connected to the cell contacting system.

### CROSS REFERENCE TO RELATED APPLICATION

The present application claims priority to German Patent Application No. 10 2024 114 705.9 filed on May 24, 2024. The entire contents of the above-listed application are hereby incorporated by reference for all purposes.

### BACKGROUND

The proposed solution relates to an energy storage unit for a vehicle.

Energy storage units comprising batteries, in particular accumulators, are widely known for use in vehicles. Usually, energy storage units for the energy supply of electrical systems, such as the drive of the respective vehicle, here are provided as so-called “battery packs”. There is provided a plurality of battery cells, which are interconnected via a cell contacting system of the energy storage unit. Via an individual connecting region of the energy storage unit, the battery cells jointly provide electric energy which is stored in the battery cells in electrochemical form.

The individual battery cells typically are provided in a sealed unit and are not accessible from outside. In the case of a possible damage of one or more battery cells, the complete energy storage unit is exchanged. Therefore, efforts typically are made above all to facilitate the exchangeability of a complete energy storage unit and its electrical connection to the energy supply system of the respective vehicle.

### SUMMARY

However, there still is a need for alternative solutions.

Against this background, there is proposed an energy storage unit for a vehicle comprising a plurality of battery cells, in which at least one of the battery cells is exchangeable and therefore is releasably connected to the cell contacting system of the energy storage unit.

The idea underlying the proposed solution thus is the provision of an energy storage unit in which at least one of the plurality of battery cells can be exchanged individually and hence without any mechanical action on the remaining battery cells of the energy storage unit. In a proposed energy storage unit at least one of the battery cells thus can be exchanged comparatively easily and in an uncomplicated way in the case of a possible functional impairment, in particular in the case of a damage, without having to replace the complete energy storage unit. Here in particular use can be made of the fact that in today's energy supply systems of vehicles it is easily possible on the software side to identify one or more damaged battery cells in a multi-cell energy storage unit and hence electronically signal to a user of the vehicle or a specialist in charge of the repair which one of the plurality of battery cells is to be exchanged so that the energy storage unit again is fully functional. The exchangeability of at least one of the battery cells in an energy storage unit for a vehicle furthermore also is advantageous from an environmental point of view, as an individual battery cell only can be exchanged specifically in the case of a possible functional impairment.

In one design variant, at least one plug connection between the at least one exchangeable battery cell and the cell contacting system is provided for the releasable connection. This for example includes a design variant in which on the at least one exchangeable battery cell at least one first connector is provided, for example in the form of a plug, which is connected to a second connector of the cell contacting system, for example in the form of a socket. In such a design variant, the at least one exchangeable battery cell can be withdrawn from the cell contacting system of the energy storage unit, when necessary. A new battery cell can be plugged into a gap present then.

In principle, it can be provided in accordance with the proposed solution that merely one battery cell or merely a particular number of battery cells of the energy storage unit is exchangeably provided. For example, the number of the exchangeable battery cells can be limited from the point of view that in the case of an amount of damaged battery cells exceeding this number a major malfunction of the energy storage unit must be assumed. The exchange of individual battery cells thus can possibly be prohibited. A limitation of the number of exchangeable battery cells for example can be provided mechanically and/or via software and/or electronically.

In particular in a design variant in which within the energy storage unit all battery cells of the plurality of battery cells are of an identical type, it may also be recommendable, however, for all battery cells of the energy storage unit to be exchangeable individually. Consequently, all battery cells here are exchangeable, when necessary, individually and hence independently of the other battery cells.

In principle, the battery cells can be arranged in an interior space of a housing of the energy storage unit and can be accessible via a housing opening of the housing, so that access into the housing is possible for exchanging one or more battery cells and a battery cell to be exchanged can be separated from the cell contacting system.

To limit the accessibility of the housing and protect the interior space from dirt and/or moisture, the housing opening can be closable by at least one cover element of the energy storage unit. The at least one cover element here can be attached to the housing in a completely removable way. Alternatively, the at least one cover element can be adjustable from a closed position on the housing into an open position. In the closed position, the housing opening is closed with the at least one cover element, while in the open position the interior space is accessible from outside via the housing opening. In such a variant, the cover element consequently is mounted on the housing so as to be adjustable between the closed position and the open position. This for example includes design variants in which the cover element is shiftable on the housing (for example via at least one plain bearing of the cover element) or is pivotable or foldable (for example via at least one joint).

To facilitate an exchange of a battery cell, an interface provided by the cell contacting system for the releasable connection with the at least one exchangeable battery cell for example can be located opposite the housing opening of the housing. By reaching into the housing opening, a person thus can directly manually grasp a battery cell, which is connected to the opposing cell contacting system.

In one design variant at least part of the battery cells or all of the battery cells is/are successively arranged on the cell contacting system along a space axis. Depending on the orientation of the energy storage unit in a state properly installed in a vehicle the battery cells in this way for example are present one beside the other or one above the other along this space axis. Consequently, the battery cells can be arranged successively along a row, in particular succeeding each other individually or in pairs along the row.

In a development based thereon, the battery cells for example are arranged offset from each other in pairs along the row in order to increase the packing density of the battery cells. Consequently, two battery cells of a pair then are each arranged offset from each other to form a succeeding pair of battery cells along the row, for example in at least one spatial direction which extends perpendicularly to the space axis, via which the row of battery cells is specified. When battery cells for example are present successively along a z-axis of a Cartesian coordinate system, the battery cells here can be arranged offset from each other in pairs along the x-direction and/or y-direction.

In a development it is provided for example that a pair of battery cells always is offset to form a pair of battery cells directly succeeding along the row, but not to form a further pair of battery cells following along the row. Every nth pair of battery cells thus is offset from an (n+1)th pair along the row, but in turn can be aligned with an (n+2)th pair of battery cells.

In principle, the battery cells can have a cylindrical, in particular circular cylindrical or prismatic shape.

Part of the proposed solution furthermore is the use of a design variant of a proposed energy storage unit for an energy supply, in particular as part of a drive system,
in a motor vehicle (in particular in a two-or four-wheel motor vehicle, thus for example in a car, motorcycle or electric scooter),
in an electric bicycle, or
in an electric kick scooter (in particular in a so-called e-scooter).

The attached Figures by way of example illustrate possible design variants of the proposed solution.

### BRIEF DESCRIPTION OF THE DRAWINGS

FIG. 1A in a sectional side view shows an energy storage unit according to a first design variant, in which a plurality of battery cells are arranged in a housing so as to succeed each other individually along a row.

FIG. 1B shows the design variant of FIG. 1A in a sectional top view.

FIG. 1C in a top view shows an individual battery cell of the energy storage unit of FIGS. 1A and 1B.

FIGS. 2A-2C show the sequence on exchange of an individual battery cell of the energy storage unit of FIGS. 1A and 1B, in which the battery cell to be exchanged is plugged off from a cell contacting system of the energy storage unit and a new battery cell is plugged into the resulting gap.

FIG. 3A in a view corresponding with FIG. 1A shows a further design variant of a proposed energy storage unit, in which the battery cells again are arranged successively along a row, but here offset from each other in pair.

FIG. 3B shows a front view of the energy storage unit of FIG. 3A with an open cover element.

FIG. 3C shows a sectional top view of the energy storage unit of FIGS. 3A and 3B.

FIG. 3D shows a battery cell of the energy storage unit of FIGS. 3A to 3C.

### DETAILED DESCRIPTION

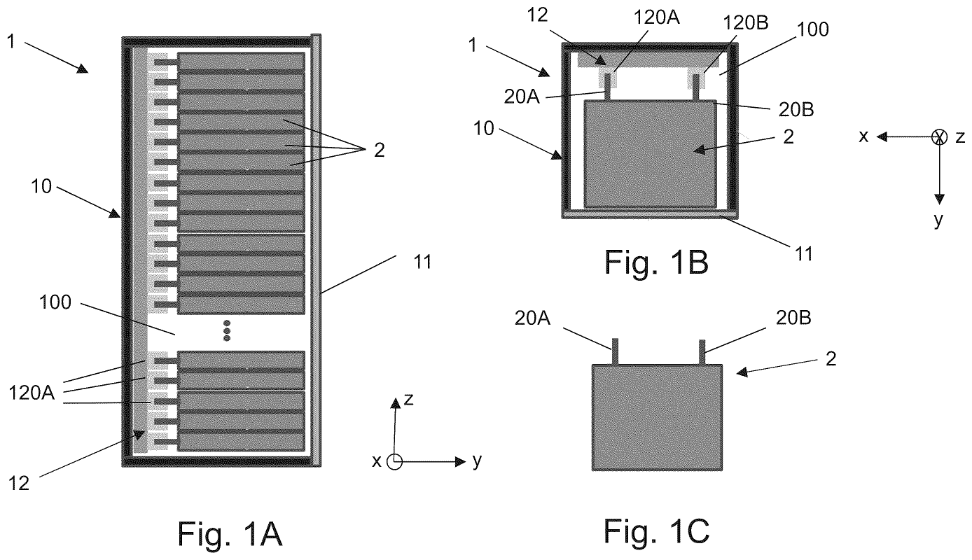

FIGS. 1A and 1B in a sectional side view show a top view of a first design variant of a proposed energy storage unit 1, which for example is adapted and provided for providing electric energy for a motor vehicle, an electric bicycle or an electric kick scooter. In a housing 10 of the energy storage unit 1 a plurality of battery cells 2 is accommodated. The battery cells 2 here are successively arranged in a row along a z-axis. With the orientation of the housing 10 of the energy storage unit 1 as shown in FIG. 1, the battery cells 2 thus are present one above the other in an interior space 100 of the housing 10. By way of example, the illustrated battery cells 2 are of the prismatic type.

The interior space 100 is closed via a cover element 11 on one side of the housing 10. This cover element 11 closes a housing opening of the housing 10, via which—with an open cover element 11—the interior space 100 is accessible from outside.

In the present case, a cell contacting system 12 of the energy storage unit 1 is located opposite the housing opening of the housing 10 to be closed by the cover element 11. Via this cell contacting system 12, the battery cells 2 are electrically interconnected so that the battery cells 2 act as a “battery pack” and jointly provide electric energy in electrochemical form, when the energy storage unit 1 is connected to an energy supply of a vehicle (via a connecting region of the energy storage unit 1).

All battery cells 2 in the present case are each connected to the cell contacting system 12 of the energy storage unit 1 of FIGS. 1A and 1B via two plug connections. On the cell contacting system 12 a pair of (connector) sockets 120A and 120B each is provided for each battery cell 2. Each battery cell 2 can be plugged thereto in an electrically conducting way by means of two plugs 20A, 20B (cf. also the individual representation of a battery cell 2 in the top view of FIG. 1C).

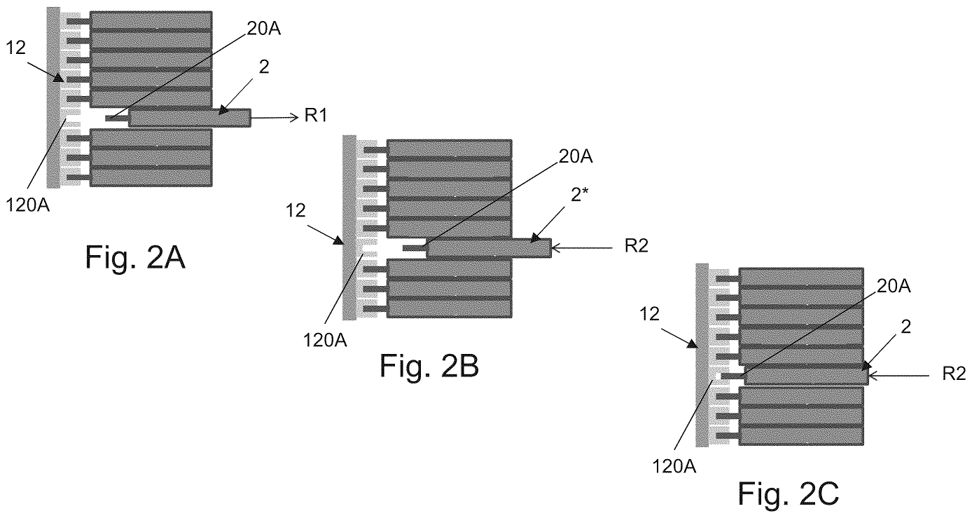

As is illustrated with reference to FIGS. 2A, 2B and 2C, each individual battery cell 2 in an energy storage unit 1 of FIGS. 1A and 1B can be exchanged independently of the other battery cells 2 of the energy storage unit 1 when necessary, for example when one of the battery cells 2 is damaged. With an open cover element 11, for example the one damaged battery cell 2 is plugged off from the cell contacting system 12 along a removal direction R1 corresponding to FIG. 2A. Into a then existing gap in the row of battery cells 2 a new, undamaged battery cell 2* is pushed along an opposite insertion direction R2, as this is illustrated in FIG. 2B. Along the insertion direction R2 the new, undamaged battery cell 2* is approached to the cell contacting system 12 and the plugs 20A, 20B of the new battery cell 2* are plugged into the sockets 120A and 120B (vacated by removing the damaged battery cell 2) of the cell contacting system 12, as this is illustrated in FIG. 2C. As a result, the new battery cell 2* then is electrically interconnected with the further battery cells 2 of the energy storage unit 1, and the energy storage unit 1 again is fully functional.

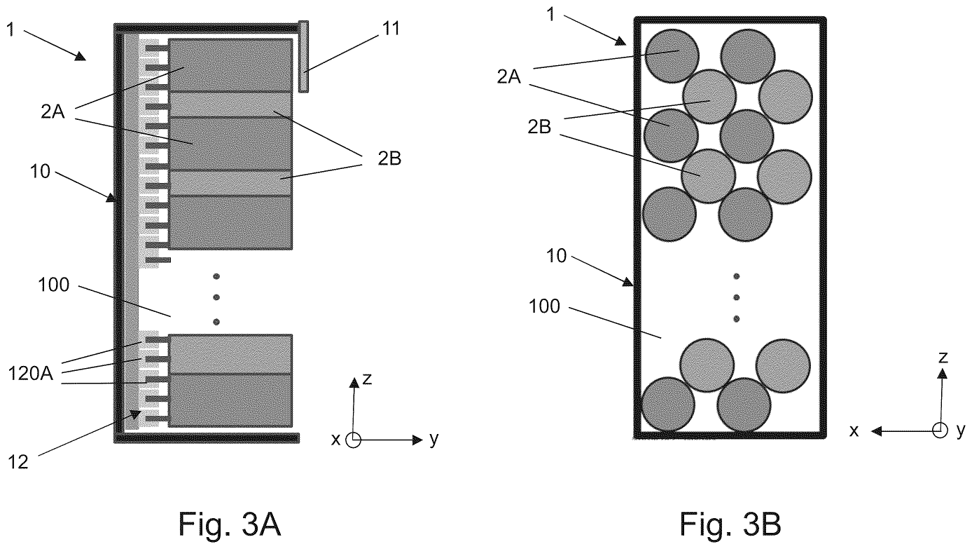

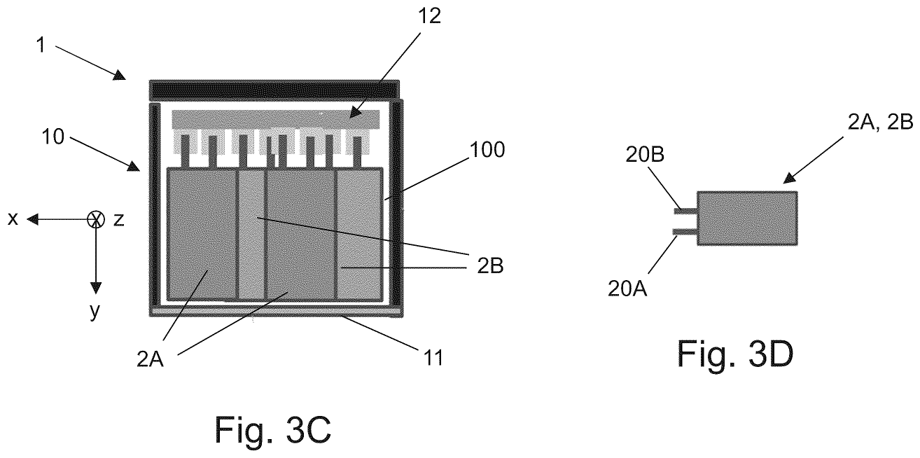

In the further design variant of a proposed energy storage unit 1, which is illustrated in FIGS. 3A to 3C, an arrangement of the battery cells 2 different from the first design variant of FIGS. 1A to 2C is provided within the interior space 100 of the housing 10. Possibly, another attachment and/or mounting of the cover element 11 here can also be provided.

As can be seen in particular with reference to the sectional representations of FIGS. 3A and 3C and the front view through the open housing opening of the housing 10 of FIG. 3B, battery cells 2A, 2B in this design variant likewise are arranged successively in a row along a Z-axis. However, the battery cells 2A, 2B here are provided successively in pairs, so that two battery cells 2A are located one beside the other in an x-direction extending perpendicularly to the z-axis and each form a pair of battery cells 2A, which is followed by a further pair of battery cells 2B along the z-axis, which is offset along the x-axis. The battery cells 2A, 2B hence are additionally arranged offset from each other in pairs along the row. Every nth pair of battery cells 2A thus is arranged offset from an (n+1)th pair of battery cells 2B along the row in the x-direction, but in turn is aligned with a succeeding (n+2)th pair of battery cells 2A. Thereby, a greater packing density of the battery cells 2A, 2B, which here are circular cylindrical, can be achieved.

### LIST OF REFERENCE NUMERALS

1 energy storage unit
10 housing
100 interior space
11 housing cover (cover element)
12 cell contacting system
120A, 120B socket (first connector)
2, 2* battery cell
2A, 2B battery cell
20A, 20B plug (second connector)
R1 removal direction
R2 insertion direction

1. An energy storage unit for a vehicle, wherein the energy storage unit includes a plurality of battery cells which for providing electric energy are electrically connected to a cell contacting system of the energy storage unit,
wherein at least one of the battery cells is exchangeable and therefore is releasably connected to the cell contacting system.

2. The energy storage unit according to claim 1, wherein for the releasable connection at least one plug connection between the at least one exchangeable battery cell and the cell contacting system is provided.

3. The energy storage unit according to claim 2, wherein on the at least one exchangeable battery cell at least one first connector is provided, which is connected to a second connector of the cell contacting system.

4. The energy storage unit according to claim 3, wherein the at least one first connector is a plug and the second connector is a socket.

5. The energy storage unit according to claim 1, wherein all battery cells of the energy storage unit are exchangeable individually.

6. The energy storage unit according to claim 1, wherein the battery cells are arranged in an interior space of a housing of the energy storage unit and are accessible via a housing opening of the housing, which can be closed by at least one cover element.

7. The energy storage unit according to claim 6, wherein the at least one cover element is attached to the housing in a completely removable way.

8. The energy storage unit according to claim 6, wherein the at least one cover element can be adjusted from a closed position on the housing, in which the housing opening is closed with the at least one cover element, into an open position on the housing, in which the interior space is accessible from outside via the housing opening.

9. The energy storage unit according to claim 6, wherein an interface provided by the cell contacting system for the releasable connection with the at least one exchangeable battery cell is located opposite the housing opening.

10. The energy storage unit according to claim 1, wherein at least part of the battery cells are successively arranged on the cell contacting system along a space axis (z-axis).

11. The energy storage unit according to claim 10, wherein the battery cells are successively arranged along a row.

12. The energy storage unit according to claim 11, wherein the battery cells are successively arranged individually or in pairs along the row.

13. The energy storage unit according to claim 12, wherein the battery cells are arranged offset from each other in pairs along the row.

14. The energy storage unit according to claim 13, wherein a pair of battery cells always is offset to form a pair of battery cells directly succeeding along the row, but not to form a further pair of battery cells following along the row.

15. The energy storage unit according to claim 1, wherein the battery cells have a cylindrical or prismatic shape.

16. (canceled)

17. The energy storage unit according to claim 15, wherein the battery cells have a circular cylindrical shape.
